(19) United States
(12) Patent Application Publication
(10) Pub. No.: US 2006/0018187 A1
(43) Pub. Date: Jan. 26, 2006

(54) Mixing device for use with insulated container

(76) Inventors: Roberto Donna, McLean, VA (US); Nancy Sabbagh, McLean, VA (US); Michel Richard, Potomac, MD (US)

Correspondence Address: KEVIN A. BUFORD;HOLLAND & KNIGHT LLP, 1600 TYSONS BOULEVARD, SUITE 700, MCLEAN, VA, 22102, US

(21) Appl. No.: 11/123,244

(22) Filed: May 6, 2005

Related U.S. Application Data
(60) Provisional application No. 60/569,342, filed on May 7, 2004.

(51) Int. Cl. B01F 7/00

(52) U.S. Cl. 366/129; 366/251

(57) ABSTRACT

Disclosed is an apparatus for use in mixing fluids within an insulated container. The apparatus allows the stored fluid to be mixed and/or poured without compromising the thermal integrity of the container. This is accomplished by providing an integrated cap that houses a mixing shaft, an optional power supply, and a pouring spout.

### RELATED APPLICATION DATA

This application claims priority to co-pending application Ser. No. 60/569,342 entitled “Thermomixer” filed on May 7, 2004, the contents of which are fully incorporated herein by reference.

### BACKGROUND OF THE INVENTION

1. Field of the Invention

This invention relates to a mixing apparatus; more particularly, the present invention relates to a mixing apparatus that includes a cap having an integrated pouring spout and mixing device.

2. Description of the Background Art

Insulated containers have been in wide use for many years and are primarily used to maintain the temperature of a stored fluid. Insulated containers can be used to maintain the temperature of very hot fluids (e.g. 210° F.) or very cold fluids (e.g. 35° F.). The effectiveness of insulated containers in maintaining temperatures depends upon the thermal integrity of the container. Likewise, internal temperatures can only be maintained by avoiding any unnecessary exposure of the fluids to ambient temperatures.

Complications arise when insulated containers are used to store fluids for long periods of time, especially where fluids may require periodic stirring to maintain the integrity of the mix. For example, sauces used in restaurant kitchens require periodic mixing to prevent separation, but these sauces must also be maintained at a desired temperature for prolonged periods. This situation presents difficulties because until now stirring could only be achieved by removing the cap of the container, thereby needlessly exposing the sauces to ambient temperature. This problem exists in other fields of endeavor as well. For example, alcoholic beverages and fluids used in scientific and laboratory settings may all need to be stirred and maintained at a specified temperature.

In sum, current insulated container design requires the container to be opened and exposed to ambient temperatures in order to stir the contents and prevent fluid separation. Likewise, conventional insulated container design requires removal of a cap or cover in order to pour the liquid. In either event, the removal of the cap unnecessarily destroys thermal integrity and may impermissibly alter the nature of the stored fluid.

### SUMMARY OF THE INVENTION

It is therefore one of the objectives of this invention to provide an insulated container that allows mixing of the container contents without exposure to ambient temperatures.

It is also an object of this invention to allow the contents of an insulated container to be poured without an unnecessary loss of thermal integrity.

Still another object of this invention is to provide a cap for a container wherein the cap integrates a pouring spout and a mixing device.

These and other objects of the invention are accomplished by providing a mixer device for use in mixing a fluid within a thermally insulated container. The device allows mixing and pouring of the stored fluid without compromising thermal integrity. The device includes a cap having a spout that can be selectively opened or closed and a power switch. The cap is removably connected to the insulated container. The cap also includes a motor and a power supply positioned within the cap. A mixer shaft is interconnected to the motor and extends into the container. A mixer propeller is included at a distal end of the shaft. Depressing the power switch activates the motor and causes rotation of the mixer shaft and mixer propeller to thereby mix the fluid. A fluid passage is formed within the cap to provide fluid communication between the container and the spout. When the spout is selectively opened fluid can be dispensed from the container without having to remove the cap.

The foregoing has outlined rather broadly the more pertinent and important features of the present invention in order that the detailed description of the invention that follows may be better understood so that the present contribution to the art can be more fully appreciated. Additional features of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a fuller understanding of the nature and objects of the invention, reference should be had to the following detailed description taken in connection with the accompanying drawings in which:

FIG. 1 is a side elevational view of the mixing apparatus of the present invention.

FIG. 2 is another side elevational view of the mixing apparatus of the present invention.

FIG. 3 is an exploded view of the mixing apparatus of the present invention.

FIG. 4 is a sectional view of the mixing apparatus of the present invention and the associated thermally insulated container.

FIGS. 5a-c are top cross sectional views illustrating the opened, partially opened, and closed orientations of the pouring ring, respectively.

FIG. 6 contains two cross sectional views of the mixing apparatus of the present invention.

FIG. 7 contains two perspective cross sectional views of the mixing apparatus of the present invention.

Similar reference characters refer to similar parts throughout the several views of the drawings.

### DETAILED DESCRIPTION OF THE PREFERRED EMBODIMENT

The present invention relates to an apparatus for mixing fluids within an insulated container. The apparatus allows the stored fluid to be mixed and/or poured without compromising the thermal integrity of the container. This is accomplished by providing a cap that integrates a mixing shaft, an optional motor/power supply, and a pouring spout. Although the cap can be removed from the container, such removal is not necessary for pouring and mixing. The various components of the present invention, and the manner in which they interrelate, will be described in greater detail hereinafter.

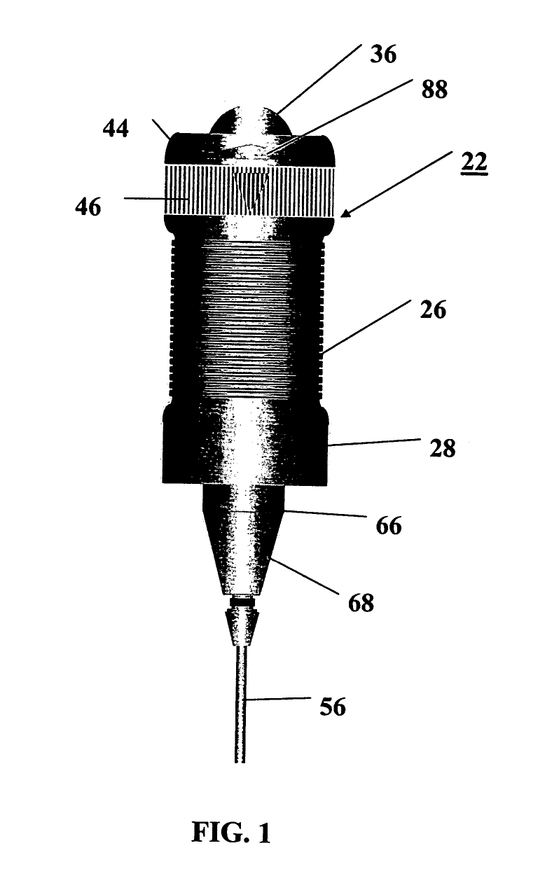

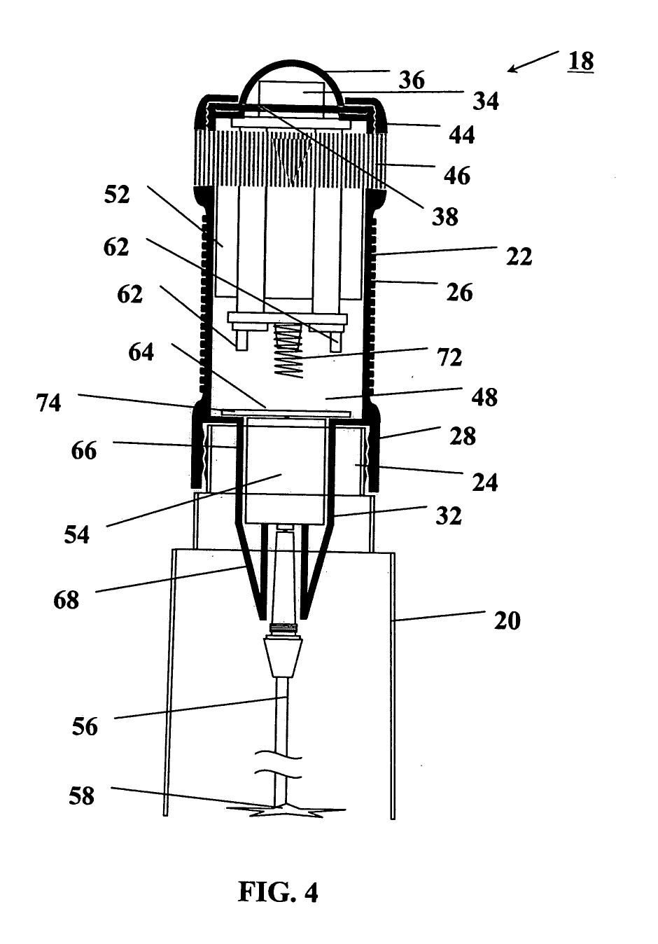

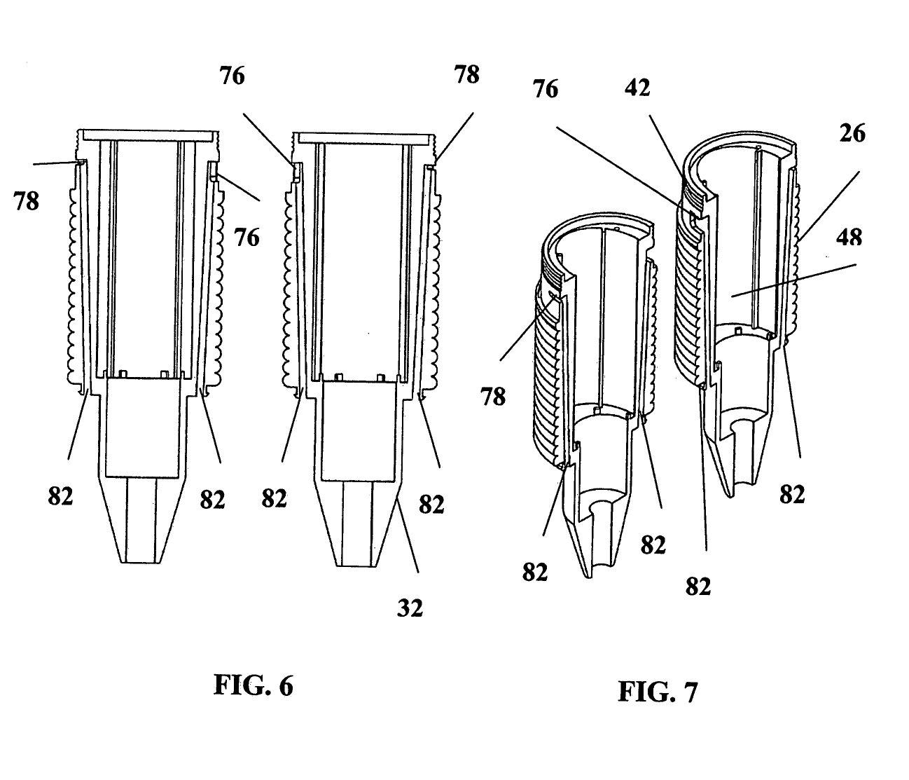

An exemplary embodiment of the present apparatus 18 is illustrated in FIGS. 1-6. These figures broadly disclose the insulated container 20 and the cap 22 that together form the apparatus 18. With specific reference to FIG. 4, container 20 of the present invention is described. In the primary embodiment container 20 is thermally insulated. However, the invention can be used with a number of different container constructions, either insulated or non-insulated. For insulated containers, many of the containers sold by Thermos® LLC of Rolling Meadows, Ill. will suffice. Container 20 can also come in any of a number of different shapes, sizes, or colors. Additionally, any of a number of different insulating constructions can be used for container 20, such as a vacuumed housing or a plastic liner. Container 20 can likewise be constructed from a variety of materials, such as stainless steel, plastic, or any other suitable material known to those skilled in the art. The preferred container construction includes a threaded opened end 24 to allow container 20 to be removably coupled to cap 22.

Cap 22 of the present invention is next described with continuing reference to FIG. 4. Cap 22 includes a main housing 26, a coupling skirt 28 and a motor housing 32. In the preferred embodiment, main housing 26 is long enough to be grasped in the hand of a user with the user's thumb being used to activate a power switch 34 located on top of cap 22. Nonetheless, the present invention can just as easily be carried out with a more truncated cap design. Power switch 34 is preferably covered with a resilient power switch cover 36 in a fluid tight manner. The fluid tight seal is maintained by a battery cap 38 that is screwed into main housing 26 over top of power switch cover 36. Main housing 26 also includes a threaded upper end 42 (note FIG. 7) to which a main cap 44 and a pouring ring 46 are secured. The fluid tight seal of the power switch cover 36 allows the entire cap 22 to be washed with water without risking damage to any internal components.

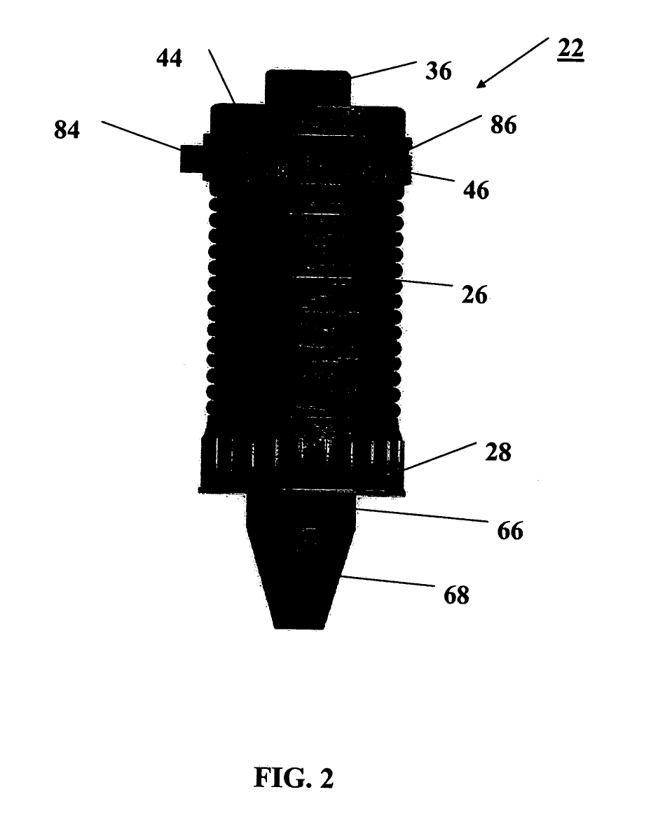

FIGS. 2 and 4 most clearly illustrate the coupling skirt portion 28 of main housing 26. Skirt 28 is formed from a threaded peripheral wall that extends downwardly from a lower end of main housing 26. Skirt 28 allows the entire cap 22 to be threadably secured to the threaded opened end 24 of the container 20 (note FIG. 4). Thus, a user can couple or uncouple the entire cap 22 as necessary by simply rotating cap 22 relative to container 20. Although the connection between cap 22 and container 20 has been described as a threaded coupling, other securing arrangements are within the scope of the present invention. For example, a frictional engagement or a locking detent can also be employed as those skilled in an art will appreciate.

The interior portion 48 of main housing 26 is illustrated in FIGS. 4 and 7. In the preferred embodiment, interior portion 48 houses a power supply 52, which can be a battery pack supplying DC voltage, such as four “AA” batteries. The use of other power supplies is within the scope of the present invention. For instance, power supply 52 can be one or more rechargeable batteries or one or more photovoltaic cells. If rechargeable batteries are used, recharging could either be accomplished by removing the batteries for connection with an external charger or a charger could be coupled directly to main housing 26 of apparatus 18. Alternatively, power can be supplied by an external source of AC power, such as from a wall outlet. It is also within the scope of the present invention to draw power from the thermal energy generated by fluids within the container. In yet another embodiment, no power supply is provided and mixing of fluids is achieved manually.

When a power supply is provided, it is used to power a motor 54 and an associated mixer shaft 56 and propeller 58. In order to allow power to be transferred from power supply 52 to motor 54, a set of electrical contacts 62 is electrically coupled to power supply 52 (note FIG. 4). These contacts 62 are adapted to engage mating contacts 64 upon motor housing 32 when the power switch 34 is engaged.

In the preferred embodiment, motor housing 32 is integrally formed with the main housing 26 and extends downwardly below coupling skirt 28. Motor housing 32 includes a cylindrical portion 66 and a lower tapered extent 68. An electric motor is preferably positioned within cylindrical portion 66 of motor housing 32 with mixing shaft 56 being coupled to the electric motor through lower tapered extent 68 of housing 32 (note FIG. 4). Motor housing 32 is sealed to allow apparatus 18 to be cleaned with water. A mixer propeller 58 is positioned at the distal end of mixer shaft 56. A compliance spring may also be incorporated into the shaft depending upon the type of motor being used and any other support provided to mixer shaft 56. As will be appreciated, with cap 22 properly secured to container 20, lower tapered extent 68 of motor housing 32 will depend into the interior of container 20 and mixing shaft and propeller (56 and 58) will extend down to about ¼ to ½ inches from the bottom of container 20.

In use, activation of power switch 34 from a first to a second orientation causes contacts 62 of power supply 52 to move downward to engage contacts 64 of electric motor 54. The union of the electrical contacts activates motor 54 to thereby impart rotation to the mixer shaft and mixer propeller (56 and 58). The spring 72 between the contacts (62 and 64) will cause their separation when power switch 34 is disengaged. A circuit board 74 can also be included within main housing 26 to provide additional functionality to power switch 34 and motor 54. For example, circuit board 74 can allow rotation at a first speed when power switch 34 is activated from a first to a second orientation and can allow rotation at a second faster speed upon activation from a second to a third orientation. Creating a circuit to achieve this objective will be known to those of skill in the art.

With reference now to FIG. 7, the openings within main housing 26 are depicted. Specifically, a discharge opening 76 and an air intake opening 78 are formed through the wall of the main housing 26 at opposite ends. These openings are preferably formed proximate to the upper end but below the threads 42 at the uppermost extent of main housing 26. The openings (76 and 78) allow for the discharge of fluid from within container 20. To achieve this, a fluid passageway 82 is associated with each of the openings (76 and 78). Each of these passageways 82 is formed within the peripheral wall of main housing 26, and the lower opened end of each passageway 82 is formed in the space between the skirt 28 (not illustrated in FIG. 7) and motor housing 32. Thus, with cap 22 properly secured to a container 20, fluid can pass from container 20 to discharge opening 76 by tipping the entire assembly 18. As is known in the art, as fluid discharges from the discharge opening 76, intake opening 78 will allow air to enter container 20, thereby ensuring a smooth fluid flow.

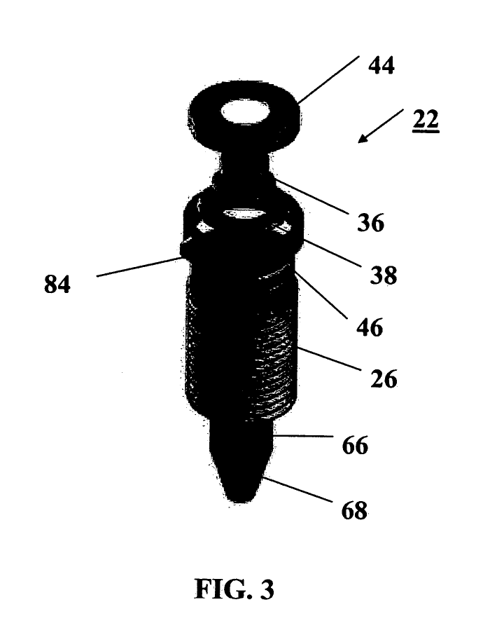

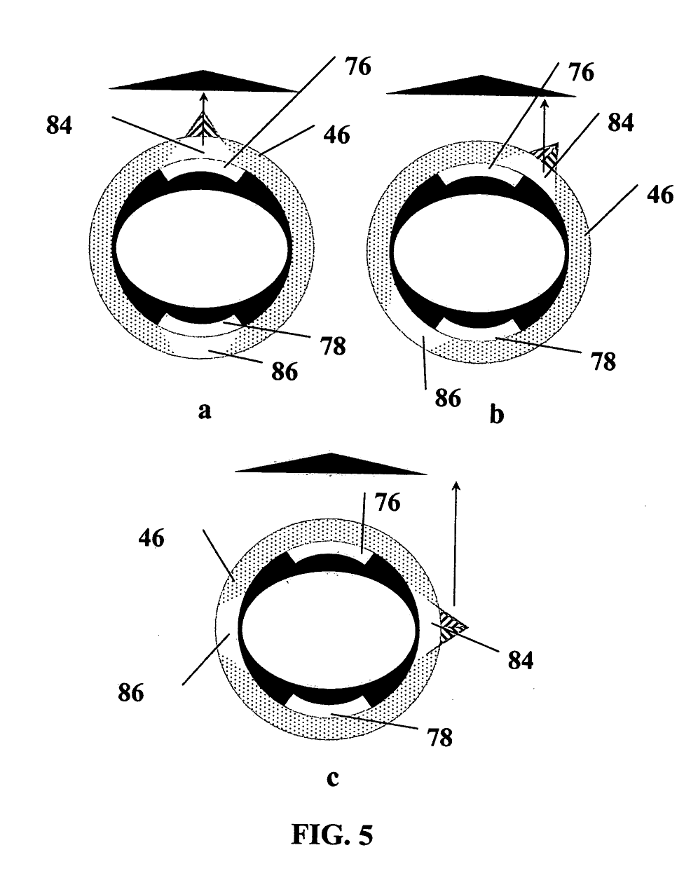

Discharge of the fluid from container 20 is further regulated by pouring ring 46. As noted in FIG. 4, pouring ring 46 is rotatably secured over the upper end of main housing 26 and includes a spout 84 (note FIGS. 2-3) and an opposite air intake opening 86 (note FIGS. 5a-c). Pouring ring 46 is secured by main cap 44 that is threadably secured to the threaded upper end 42 of main housing 26. Again, although a threaded interconnection is specified in the preferred embodiment, other securing means are known in the art. Whatever connection is used, main cap 44 should be secured in a manner that allows pouring ring 46 to freely rotate about main housing 26. Through such rotation, spout 84 and air intake 86 of pouring ring 46 can be selectively brought into registry with the discharge and air intake openings (76 and 78) of main housing 26.

As noted in the cross sectional views of FIGS. 5a-c, when all the openings (76, 78, 84 and 86) are in registry, and assembly 18 is inverted, fluid will flow from container 20 and out of spout 84 while air is simultaneously delivered through intakes (78 and 86) (note FIG. 5a). Thus, the fluid can be dispensed from container 20 without having to remove the entire cap 26. This flow rate can be decreased by simply turning pouring ring 46 slightly such that there is no longer a perfect registry between the openings of the housing (76 and 78) and the openings of the pouring ring (84 and 86) (note FIG. 5b). If no flow is desired, such as during storage, pouring ring 46 is turned such that the openings in pouring ring 46 and main housing 26 are no longer in registry (note FIG. 5c). Indicators 88 can be marked on main cap 44 and pouring ring 46 (note FIG. 1) to indicate if the various openings are in registry with one another. Other flow regulating mechanisms will be appreciated by those skilled in the art. For example, cap 22 can include a pouring mechanism that is activated by a push button switch, whereby pressing the switch opens the orifice and allows the stored fluid to be poured.

Moreover, the electric motor and battery cells depicted in FIG. 4 can be eliminated completely and replaced with a mechanical spinning device that is activated with mechanical action by the user such as a spring wound device, a geared rotating system, or a gravity operated device. The motor 54 and power supply 52 can also be eliminated completely and replaced with a thermal engine that converts the heat generated from the stored fluid into mechanical action of the mixer shaft and mixer propeller.

The invention can also incorporate a programmable timer to activate the mixing action at user selected times, thereby maintaining the integrity of the stored fluid mixture at all times.

The invention can further incorporate an internal temperature sensor connected to an external digital display mounted on the container or elsewhere to alert the user to the temperature of the stored fluid at all times, multiple sensors to detect variations or other indicators that may be used to determine the need to further chill or stir the stored fluid.

In yet another alternative embodiment, cap 22 can be used in conjunction with a non-insulated container. This embodiment is for use with fluids that might not require thermal stability but that would nonetheless benefit from the integrated mixing and pouring that are provided for by cap 22. For example, a non-insulated container can be used to create, mix and pour a salad dressing. This has the advantage of eliminating many of the appliances and dishes that would otherwise have to be used to create the dressing. Once created, the non-insulated container can store the salad dressing to allow subsequent mixing before pouring to thereby avoid separation. This eliminates the need of opening the container and stirring the dressing.

The present disclosure includes that contained in the appended claims, as well as that of the foregoing description. Although this invention has been described in its preferred form with a certain degree of particularity, it is understood that the present disclosure of the preferred form has been made only by way of example and that numerous changes in the details of construction and the combination and arrangement of parts may be resorted to without departing from the spirit and scope of the invention.

Now that the invention has been described,

What is claimed is:

1. A mixing apparatus comprising in combination:
a thermally insulated container having a threaded opened end;
a cap having a main housing with a periphery, a threaded upper end and a threaded coupling skirt at a lower end, the coupling skirt threadably securing the cap to the threaded opened end of the container, the main housing including an interior portion, a battery pack positioned within the interior portion, a set of electrical contacts electrically coupled to the battery pack, the main housing further including both a discharge opening and an opposite air intake opening formed proximate the upper end, a power switch operatively connected to the upper end of the main housing and the battery pack, the power switch having first, second, and third orientations;
a pouring ring rotatably secured over the upper end of the main housing, the pouring ring having a spout and an opposite air intake opening, a main cap threadably secured to the threaded upper end of the main housing thereby securing the pouring ring to the main housing, the spout and air intake of the pouring ring being selectively registerable with the discharge opening and air intake opening of the main housing;
a motor housing integrally formed with the main housing and extending downwardly below the coupling skirt, an electric motor positioned within the motor housing, the electric motor including electrical contacts that can be engaged by the electrical contacts of the battery pack, a mixer shaft coupled to the electric motor and extending into the container, a mixer propeller at a distal end of the mixer shaft, whereby activation of the power switch from the first to the second orientation causes the contacts of the battery pack to engage the contacts of the electric motor to thereby impart rotation to the mixer shaft and mixer propeller, activation of the power switch from the second to the third orientation causing the mixer shaft and mixer propeller to rotate at an increased speed;
first and second fluid passages formed within the periphery of the main housing, the first fluid passage providing fluid communication between the container and the discharge opening of the main housing, the second fluid passage providing fluid communication between the container and the air intake opening of the main housing, whereby when the spout and air intake of the pouring ring are in registry with the discharge opening and air intake opening of the main housing, fluid can be dispensed from the container without having to remove the cap.

2. A mixing device for use in mixing a fluid within a thermally insulated container, wherein mixing and pouring of the fluid can be accomplished without compromising the thermal integrity of the container, the device comprising:
a cap having a spout that can be selectively opened or closed and a power switch, the cap being removably secured to the container;
a motor and power supply positioned within the cap, a mixer shaft interconnected to the motor and extending into the container, a mixer propeller at a distal end of the mixer shaft, whereby depressing the power switch activates the motor and causes rotation to the mixer shaft and mixer propeller to thereby mix the fluid;
a fluid passage formed within the cap to provide fluid communication between the container and the spout, whereby when the spout is selectively opened fluid can be dispensed from the container without having to remove the cap.

3. The mixing device as described in claim 2 wherein the motor is an electric motor and the power supply is one or more rechargeable batteries.

4. The mixing device as described in claim 2 wherein the power supply is one or more photovoltaic cells.

5. The mixing device as described in claim 2 wherein the power supply is from an external source of AC power.

6. The mixing device as described in claim 2 wherein the power supply is a battery providing DC power.

7. The mixing device as described in claim 2 wherein the power supply is the thermal energy of the fluid within the container.

8. The mixing device as described in claim 2 wherein the spout is mounted upon a rotatable pouring ring and wherein the spout can be opened or closed depending upon the orientation of the pouring ring.

9. The mixing device as described in claim 2 wherein the cap is threadably and removably secured to the container via a coupling skirt.

10. A mixing device for use in mixing a fluid within a thermally insulated container, whereby a user can mix and pour the fluid without compromising the thermal integrity of the container, the device comprising:
a cap having a spout, the cap being removably secured to the container;
a mixer shaft interconnected to the cap and extending into the container, a mixer propeller at a distal end of the mixer shaft, the mixer shaft being rotatable by a user such that the mixer propeller mixes the fluid;
a fluid passage formed within the cap to provide fluid communication between the container and the spout.
